(19) United States
(12) Patent Application Publication
(10) Pub. No.: US 2005/0044000 A1
(43) Pub. Date: Feb. 24, 2005

(54) Competitive product pricing using simulated orders

(75) Inventor: Chandrasekhar Narayanaswami, Wilton, CT (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: International Business Machines Corporation, Armonk, NY (US)

(21) Appl. No.: 10/643,284

(22) Filed: Aug. 18, 2003

(51) Int. Cl. G06F 17/60

(52) U.S. Cl. 705/26

(57) ABSTRACT

A system, method and computer readable medium for pricing products and/or services on a web site is disclosed. The method on a web site includes offering a product and/or service for sale on a first web site, wherein the product and/or service is available for purchase in a plurality of configurations. The method further includes determining on a second web site a price for each of the plurality of configurations of the product and/or service and calculating a price for each of the plurality of configurations of the product and/or service based on the prices determined from the second web site and at least one price factor. The method further includes offering each of the plurality of configurations of the product and/or service for sale on the first web site for the calculated prices.

### BACKGROUND OF THE INVENTION

1. Field of the Invention

This invention generally relates to the field of e-commerce web sites and more specifically to competitive pricing on e-commerce web sites.

2. Description of Related Art

As use of the World Wide Web increases, businesses and individuals are increasingly turning to this medium to conduct their business. The web has proven itself as a very efficient tool for conducting business and selling products and services. Traditional brick and mortar retailers have come to realize that the World Wide Web is another distribution channel that they can utilize to increase their sales both in-store and online, as well as improve their overall customer's satisfaction.

With the advent of this new medium as a retail distribution channel comes the inherent challenges associated with selling products via an electronic medium. Many products and/or services sold over the web are available in a variety of configurations. A computer, for example, can be configured in a variety of ways so as to provide varying sizes of hard disk space and memory. Typically, a consumer visits a web site and selects a particular configuration of a product, such as a computer. Subsequently, the web site calculates a price based on the selected configuration. This paradigm, however, makes it difficult to monitor the prices of competitors as the selection of a configuration is necessary.

Price is still a major buying factor that is used to attract and retain web customers. As such, people running the web sites for electronic commerce, typically monitor competitor prices and adjust their own prices based on this and other price factors. This process is often a combination of manual and traditional methods used in regular commerce and looking at prices listed on the web by competitors. Third party web sites provide price comparison tools for simple and well specified products, such as a particular model of a camcorder. However, the current process does not support the selection of options of a particular product and/or service so as to create a configuration of the product and/or service. Thus, in situations where a configurable product, such as a computer, is in issue, it is not possible to monitor competitor prices in an automated fashion. Other configurable products include furniture, cars, boats, etc.

Therefore a need exists to overcome the problems with the prior art as discussed above, and particularly for a way to more efficiently calculate competitive prices.

### SUMMARY OF THE INVENTION

Briefly, in accordance with the present invention, disclosed is a system, method and computer readable medium for pricing products and/or services on a web site. In an embodiment of the present invention, the method on a web site includes offering a product and/or service for sale on a first web site, wherein the product and/or service is available for purchase in a plurality of configurations. The method further includes determining on a second web site a price for each of the plurality of configurations of the product and/or service and calculating a price for each of the plurality of configurations of the product and/or service based on the prices determined from the second web site and at least one price factor. The method further includes offering each of the plurality of configurations of the product and/or service for sale on the first web site for the calculated prices. The step of determining comprises visiting the second web site during the transaction (so that the latest pricing information is available), selecting each of the plurality of configurations on the second web site and reading from the second web site a price associated with each of the plurality of configurations.

In one embodiment of the present invention, the at least one price factor further includes information associated with a buyer of the product and/or service on the first web site. In another embodiment of the present invention, the information associated with the buyer of the product and/or service on the first web site includes the volume of the product and/or service that is being purchased by the buyer, the number of orders previously placed by the buyer on the first web site, the type of equipment owned by the buyer and the classification of the buyer.

In another embodiment of the present invention, a system for pricing a product and/or service on a web site is disclosed. The system comprises a first web site for offering a product and/or service for sale, wherein the product and/or service is available for purchase in a plurality of configurations and a spider for determining on a second web site a price for each of the plurality of configurations of the product and/or service. The system further includes a processor for calculating a price for each of the plurality of configurations of the product and/or service based on the prices determined from the second web site and at least one price factor and a price module for adjusting the prices of each of the plurality of configurations of the product and/or service to the prices calculated by the processor.

In one embodiment of the present invention, the at least one price factor includes any one of the highest price that the market will bear for each of the plurality of configurations of the product and/or service on the first web site and the lowest profitable price at which the first web site can sell each of the plurality of configurations of the product and/or service.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram illustrating the overall system architecture of one embodiment of the present invention.

FIG. 2 is a block diagram depicting the overall operation and control flow of the pricing process, according to one embodiment of the present invention.

FIG. 3 is an illustration of a conventional product configuration web page.

FIG. 4 is a block diagram showing the system components used during the pricing process, according to one embodiment of the present invention.

FIG. 5 is a flowchart depicting the operation and control flow of the overall process of one embodiment of the present invention.

FIG. 6 is a flowchart depicting the operation and control flow of the price collection process of one embodiment of the present invention.

FIG. 7 is a block diagram of a computer system useful for implementing an embodiment of the present invention.

### DETAILED DESCRIPTION OF THE PREFERRED EMBODIMENTS

The present invention, according to a preferred embodiment, overcomes problems with the prior art by providing an efficient and easy-to-implement system for providing competitive pricing of products to online shoppers. The exemplary embodiments of the present invention provide a system wherein a retail web site uses simulated orders at a competitor's web site to calculate competitive prices.

Overview

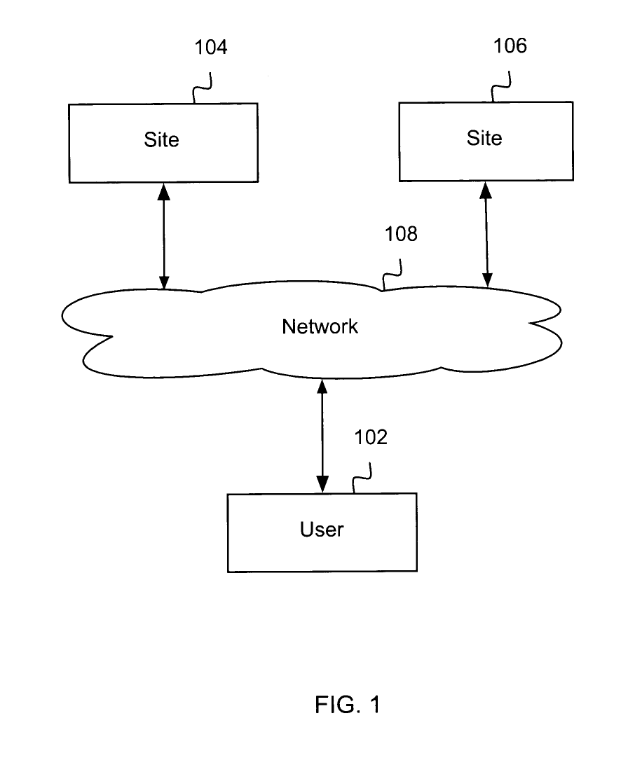

FIG. 1 is a block diagram illustrating the overall system architecture of one embodiment of the present invention. The exemplary embodiments of the present invention adhere to the system architecture of FIG. 1.

A web site 104, typically an e-commerce web site that sells products and/or services, is connected to a wide area network 108, such as the Internet. A user 102, operating on a client information processing system, or client computer, is also connected to the network 108. The user 102 utilizes a client application, such as a web browser, on his client computer to connect to the web site 104 via the network 108. Once connected to the web site 104, the user 102 browses through the products and/or services offered by web site 104 by navigating through the web pages on the site. The products and/or services offered by web site 104 are available in a plurality of configurations. Subsequently, the web site 104 will offer a selected configuration of a product and/or service for sale to the user 102 at a given price. The user 102 then has the option of purchasing the configuration of the product and/or service online, or while connected to the web site 104.

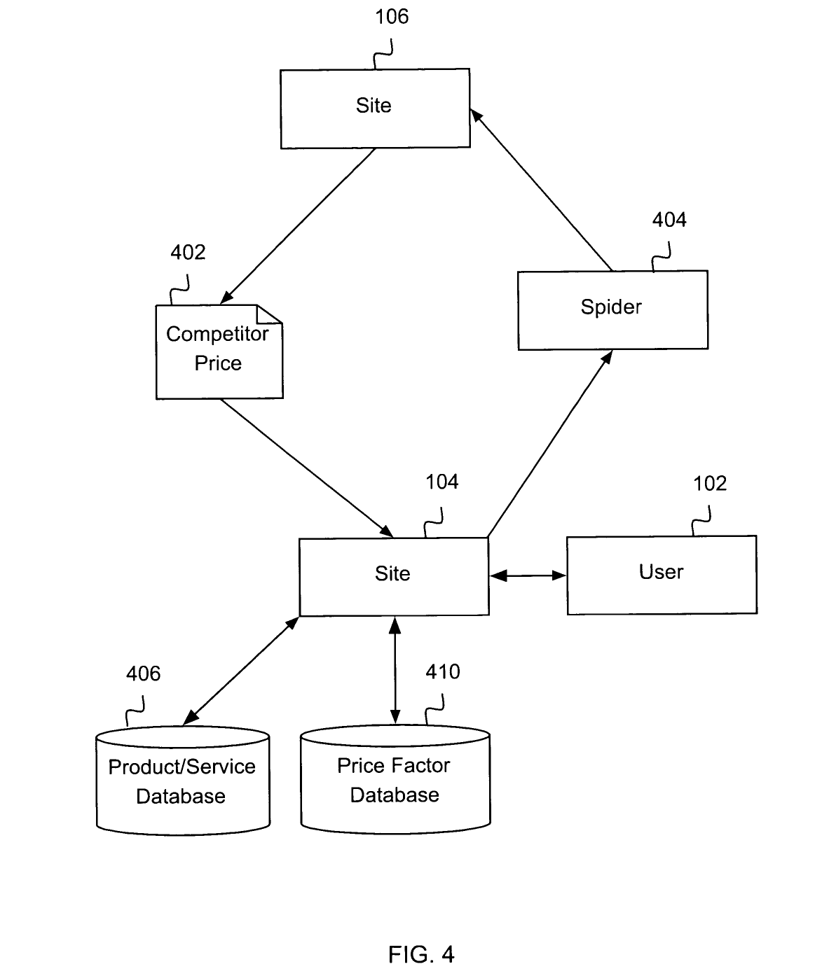

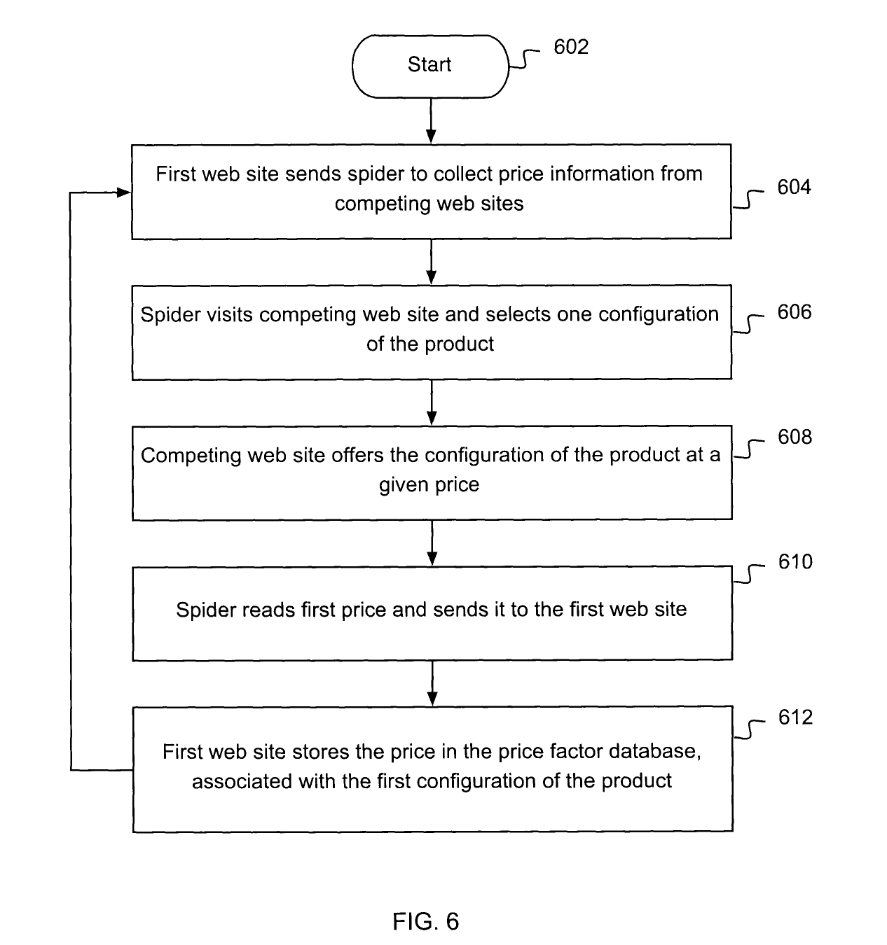

Web site 106 is a similar web site that is a competitor to the web site 104. Web site 106 sells the same or similar products and/or services as offered by web site 106. In order to provide competitive pricing, the web site 104 collects pricing information from the competitor web site 106. This is described in greater detail with reference to FIG. 6 below. Then, the web site 104 calculates a price for each configuration of the product and/or service based on the prices collected from the web site 106 and other price factors. This is also described in greater detail with reference to FIGS. 4-6 below. It should be noted that although FIG. 1 shows only one competing web site 106 and one user 102, the system of the present invention supports any number of competing web sites and any number of users.

In an embodiment of the present invention, certain actions performed by user 102, such as the selection of a configuration of a product and/or service on a web page of web site 104, are performed by a client application, such as a Java applet, a Java scriptlet, Java script, Perl script or an Active X control. In another embodiment of the present invention, certain actions performed by site 104, such as the pricing of a configuration of a product and/or service offered for sale at the web site 104, are performed by a server application on the server 104 such as a Common Gateway Interface (CGI) script, a Java servlet, a Hypertext Preprocessor (PHP) script or a Perl script.

In another embodiment of the present invention, the computer systems of site 104, site 106 and user 102 are one or more Personal Computers (PCs) (e.g., IBM or compatible PC workstations running the Microsoft Windows 95/98/2000/ME/CE/NT/XP operating system, Macintosh computers running the Mac OS operating system, or equivalent), Personal Digital Assistants (PDAs), game consoles or any other information processing devices. In another embodiment of the present invention, the computer systems of site 104, site 106 and user 102 are server systems (e.g., SUN Ultra workstations running the SunOS operating system or IBM RS/6000 workstations and servers running the AIX operating system).

FIG. 1 also shows network 108 for connecting client 102 to web sites 104 and 106. In one embodiment of the present invention, network 108 is a circuit switched network, such as the Public Service Telephone Network (PSTN). In another embodiment of the present invention, the network 108 is a packet switched network. The packet switched network is a wide area network (WAN), such as the global Internet, a private WAN, a local area network (LAN), a telecommunications network or any combination of the above-mentioned networks. In another embodiment of the present invention, network 108 is a wired network, a wireless network, a broadcast network or a point-to-point network.

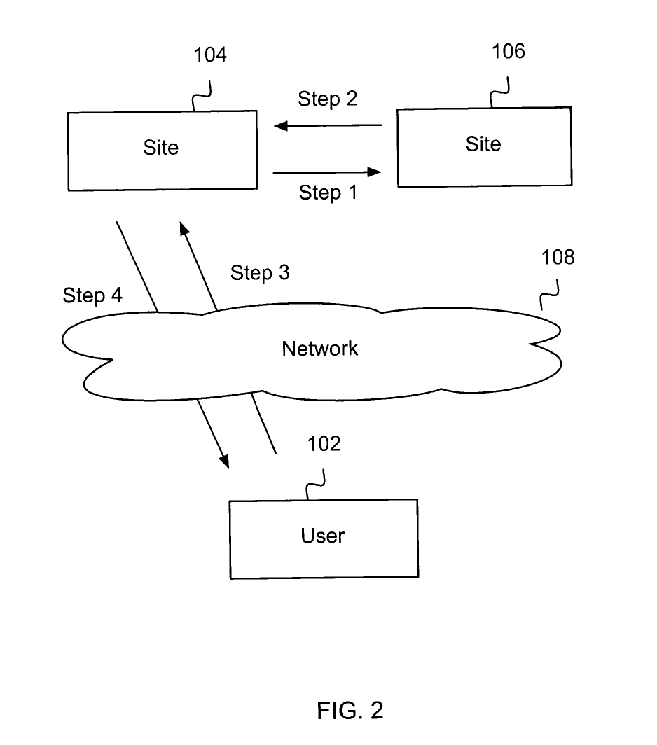

FIG. 2 is a block diagram depicting the overall operation and control flow of the pricing process, according to one embodiment of the present invention. FIG. 2 shows four steps describing in more detail the process of calculating competitive prices and offering them to customers.

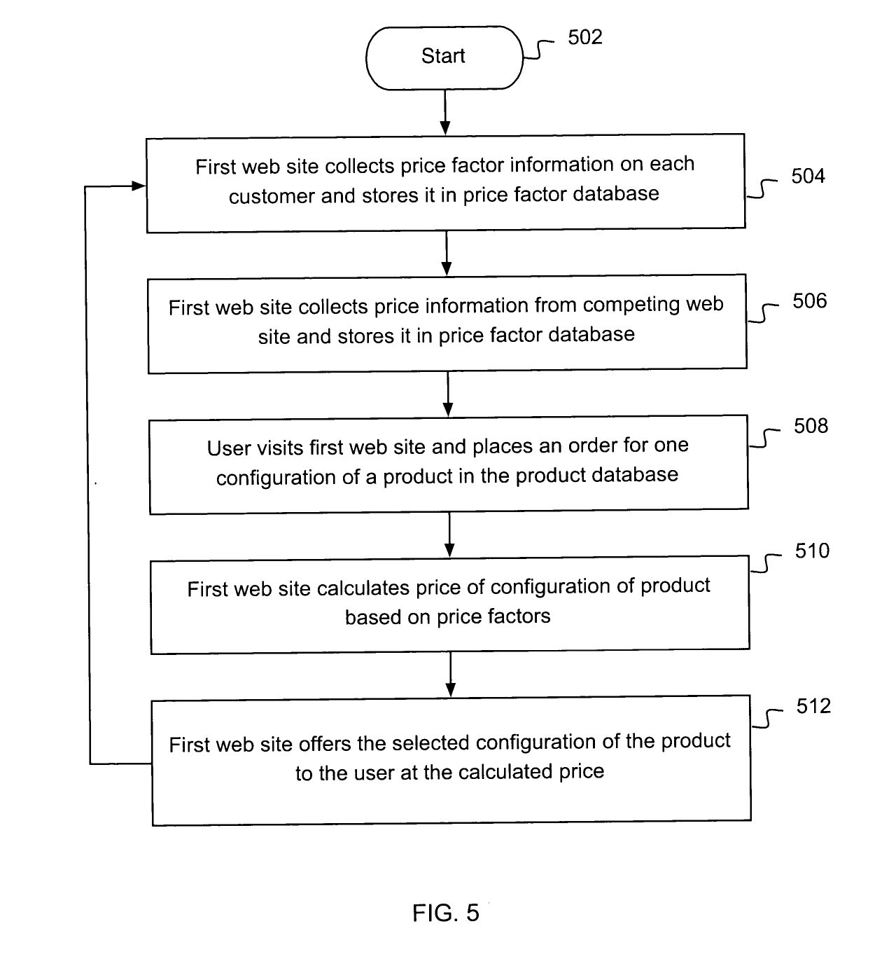

As explained above, the web site 104 is an exemplary e-commerce web site that sells products and/or services over the Internet. Web site 106 is a similar web site that is a competitor to the web site 104. Web site 106 sells the same or similar products and/or services as offered by web site 106. In order to provide competitive pricing, the web site 104 visits the web site 106 in step 1 and collects pricing information from the web site 106 in step 2. This is described in greater detail with reference to FIG. 6 below. Subsequently, the web site 104 calculates a price for each configuration of the product and/or service based on the prices collected from the web site 106 and other price factors. This is described in greater detail with reference to FIG. 5 below.

Next, in step 3, the user 102 utilizes a client application, such as a web browser, on his client computer to connect to the web site 104 via the network 108. Once connected to the web site 104, the user 102 browses through the products and/or services offered by web site 104 by navigating through the web pages on the site. The products and/or services offered by web site 104 are available in a plurality of configurations. Subsequently, in step 4, the web site 104 will offer a selected configuration of a product and/or service for sale to the user 102 at a given price. The user 102 then has the option of purchasing the configuration of the product and/or service online, or while connected to the web site 104.

In optional steps before steps 1 through 4, the web site 104 collects information pertaining to certain customers or users 102. Examples of information pertaining to users 102 that is collected by the web site 104 includes: the volume of the product and/or service that is being purchased by the user, the number of orders previously placed by the user on the web site 104, the type of equipment or products owned by the user and the classification of the user (educational, commercial, home user, etc.). This information is later used as price factors that are used to calculate a competitive price for the products and/or services offered on the web site 104. This is described in greater detail with reference to FIG. 5 below.

In one alternative, step 3 occurs before steps 1 and 2. In this alternative, the web site 104 collects pricing information from competitor web sites during or after the transaction of user 102. That is, the web site 104 checks competitor pricing information after or during the user transaction of placing an order for a product or service. This allows the web site 104 to acquire the most up-to-date and accurate competitor pricing information possible. Subsequently, step 4 is executed, i.e., the web site 104 offers the product or service to the user 102 at the calculated price.

Competitive Pricing Process

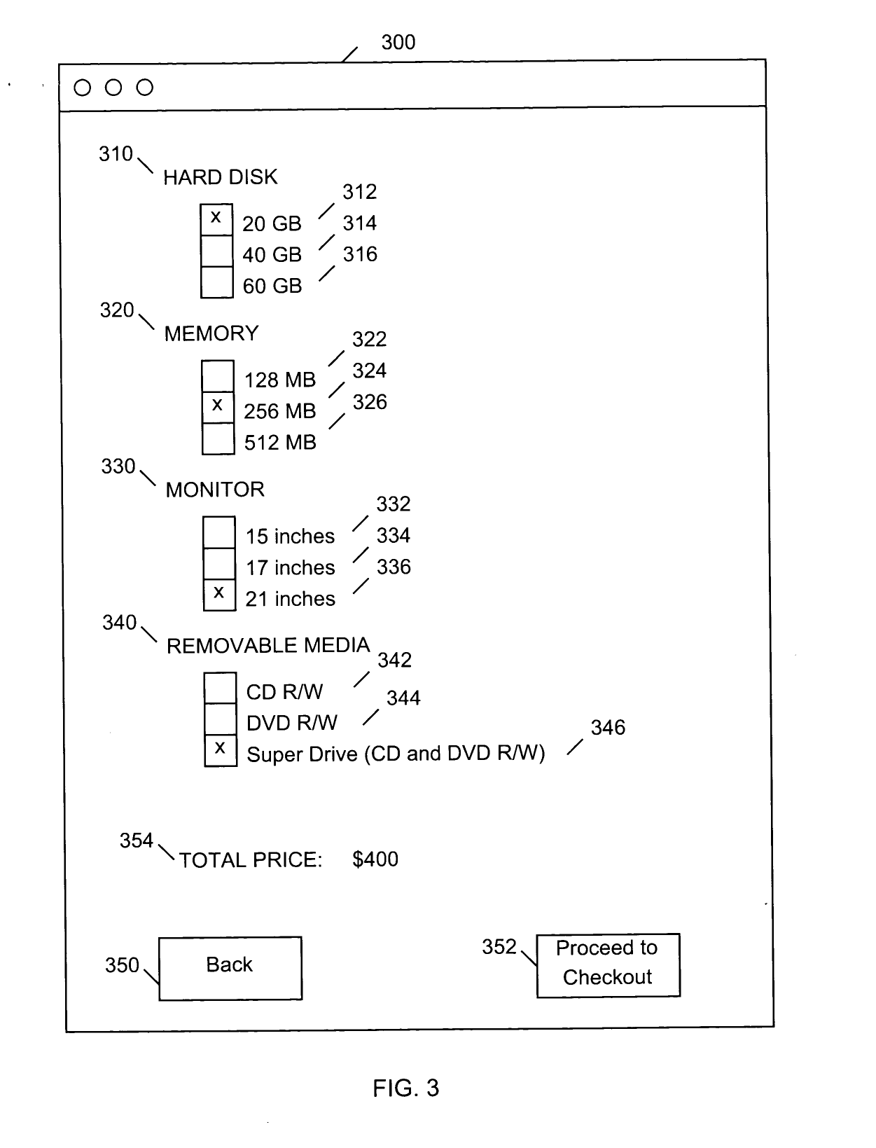

FIG. 3 is an illustration of a conventional product configuration web page 300. FIG. 3 shows a conventional web page 300 that is used to select a configuration of a product for sale on a web site such as web site 104 or 106. Exemplary FIG. 3 shows a web page 300 that is used by a user 102 for selecting a configuration of a computer for sale on a web site, such as web site 104 or 106.

FIG. 3 shows a first configuration selection 310 for specifying the type of hard disk desired by the user 102 in the computer he intends to purchase. The first configuration selection 310 includes three options 312, 314 and 316, corresponding to 20 Gigabytes (GB), 40 GB and 60 GB, respectively. Next to each of the three options 312, 314 and 316 is a check box for selecting one option. FIG. 3 shows that the user 102 has selected option 312.

FIG. 3 also shows a second configuration selection 320 for specifying the type of memory desired by the user 102 in the computer he intends to purchase. The second configuration selection 320 includes three options 322, 324 and 326, corresponding to 128 Megabytes (MB), 256 MB and 512 MB, respectively. Next to each of the three options 322, 324 and 326 is a check box for selecting one option. FIG. 3 shows that the user 102 has selected option 324.

FIG. 3 also shows a third configuration selection 330 for specifying the type of monitor desired by the user 102 in the computer he intends to purchase. The third configuration selection 330 includes three options 332, 334 and 336, corresponding to 15 inches, 17 inches and 21 inches, respectively. Next to each of the three options 332, 334 and 336 is a check box for selecting one option. FIG. 3 shows that the user 102 has selected option 336.

FIG. 3 also shows a fourth configuration selection 340 for specifying the type of removable media desired by the user 102 in the computer he intends to purchase. The fourth configuration selection 340 includes three options 342, 344 and 346, corresponding to a Compact Disc Read/Write (CD R/W) drive, a Digital Versatile Disc (DVD) R/W drive and a Super Drive (CD R/W and DVD R/W), respectively. Next to each of the three options 342, 344 and 346 is a check box for selecting one option. FIG. 3 shows that the user 102 has selected option 346.

Further, FIG. 3 shows a total price line 354, which indicates the price at which the web site is offering for sale the particular configuration of the computer selected in the web page 300. FIG. 3 also shows a back button 350 for navigating a web page displayed previous to web page 300 and a “proceed to checkout” button 352 for continuing the process of purchasing the computer that was selected in the web page 300.

FIG. 4 is a block diagram showing the system components used during the pricing process, according to one embodiment of the present invention. FIG. 4 shows describes in more detail the components used during the process of calculating competitive prices and offering them to customers.

The web site 104 comprises routines or programs known as spiders 404. A spider 404 is a program that automatically fetches web pages and/or extracts or retrieves information. Spiders can be used to feed web pages to search engines. Another term for a spider is a webcrawler. The spider 404 of the web site 104 visits the web site 106 and collects pricing information 402 from the web site 106. This is described in greater detail with reference to FIG. 6 below.

As explained above, the price information 402 is considered price factor information, as it is utilized by the web site 104 in calculating competitive prices of the products and/or services offered by the web site 104. Subsequently, the web site 104 collects the price information 402 and stores it in price factor database 410. The price factor database 410 is any commercially available database, such as the DB2 Universal Database available from International Business Machines of Armonk, N.Y.

Optionally, the web site 104 collects information pertaining to certain customers or users 102. Examples of information pertaining to users 102 that is collected by the web site 104 are provided above with reference to FIG. 2. This information is stored in price factor database 410. The price factor database 410 can also include other information, such as the highest price that the market will bear for each of the plurality of configurations of the product and/or services on the web site 104 and the lowest profitable price at which the web site 104 can sell each of the plurality of configurations of the product and/or services on the web site 104. The information in the price factor database 410 is later used as price factors that are used to calculate a competitive price for the products and/or services offered on the web site 104.

The product and/or service database 406 is used to store information pertaining to the products and/or services offered for sale on web site 104. Examples of information that is stored in product and/or service database 406 include: an image of the product and/or service, the price of the product and/or service, feature information of the product and/or service, promotional information pertaining to the product and/or service, configuration information pertaining to the product and/or service and shipping information pertaining to the product and/or service. Like the price factor database 410, the product and/or service database 406 is any commercially available database

The web site 104 calculates a price for each configuration of the product and/or service in the product and/or service database 406 based on the information in the price factor database 410. This is described in greater detail with reference to FIG. 5 below.

The user 102 connects to the web site 104 and browses through the products and/or services offered by web site 104 by navigating through the web pages on the site. The products and/or services offered by web site 104 are available in a plurality of configurations. The web site 104 will offer a selected configuration of a product and/or service for sale to the user 102 at a given price. The user 102 then has the option of purchasing the configuration of the product and/or service online, or while connected to the web site 104.

FIG. 5 is a flowchart depicting the operation and control flow of the overall process of one embodiment of the present invention. FIG. 5 describes in more detail the processes of calculating competitive prices and offering them to customers. The control flow of FIG. 5 begins with step 502 and flows directly to step 504.

In step 504, the web site 104 collects price factor information pertaining to each customer and stores it in price factor database 410. As explained above, this is an optional step. Examples of information pertaining to users 102 that is collected by the web site 104 are provided above with reference to FIG. 2. This information is later used as price factors that are used to calculate a competitive price for the products and/or services offered on the web site 104.

In step 506, the web site 104 collects pricing information 402 from the web site 106. Specifically, the spider 404 of the web site 104 visits the web site 106 and collects pricing information 402 from the web site 106. The price information 402 is considered price factor information, as it is utilized by the web site 104 in calculating competitive prices of the products and/or services offered by the web site 104.

In step 508, the user 102 connects to the web site 104 and browses through the products and/or services offered by web site 104 by navigating through the web pages on the site. The products and/or services offered by web site 104 are available in a plurality of configurations. The user 102 chooses one configuration of a product and/or service.

It should be noted that the pricing schemes on competitor web sites can be very complex. For example, the price of a removable media may be zero if the user chooses a 60 GB disk and $100 if the user chooses a 20 GB disk. Also, some web sites show price for each option at the end of the selection of that option, while other web sites show a total price after all options have been selected. Thus, the simulation of the order on the competitor web site dynamically during the user transaction or statically after the user transaction. This is discussed in greater detail below. In essence, the first web site 102 simulates the user's order on the second web site 104 to get the latest and most accurate price information.

In step 510, the web site 104 calculates a price for the configuration of the product and/or service, chosen by the user 102, based on the information in the price factor database 410. As explained above, the price factor database 410 can include information pertaining to the user 102, such as the volume of the product and/or service that is being purchased by the user 102, the number of orders previously placed by the user on the web site 104, the type of equipment or products owned by the user 102 and the classification of the user 102. The price factor database 410 can also include other information, such as the highest price that the market will bear for each of the plurality of configurations of the product and/or services on the web site 104 and the lowest profitable price at which the web site 104 can sell each of the plurality of configurations of the product and/or services on the web site 104.

In one example, the web site 104 calculates a price for the configuration of the product and/or service chosen by the user 102 by performing the following steps: 1) read the price offered by the competitor for the chosen configuration of the product and/or service, 2) if the competitor price is higher than the lowest profitable price at which the web site 104 can sell this configuration of the product and/or service, offer this configuration of the product and/or service at the competitor's price, 3) if competitor price is lower than the lowest profitable price at which the web site 104 can sell this configuration of the product and/or service, offer this configuration of the product and/or service at the lowest profitable price.

In another example, the web site 104 calculates a price for the configuration of the product and/or service chosen by the user 102 by performing the following steps: 1) read the price offered by the competitor for the chosen configuration of the product and/or service, 2) if the competitor price is higher than the highest price that the market will bear for the configuration of the product and/or service, offer this configuration of the product and/or service at the highest price that the market will bear, 3) if competitor price is lower than the highest price that the market will bear for the configuration of the product and/or service and higher than the lowest profitable price at which the web site 104 can sell this configuration of the product and/or service, offer this configuration of the product and/or service at the competitor's price, 4) if competitor price is lower than the lowest profitable price at which the web site 104 can sell this configuration of the product and/or service, offer this configuration of the product and/or service at the lowest profitable price.

Returning to the control flow of FIG. 5, in step 512, the web site 104 offers the selected configuration of the product and/or service for sale to the user 102 at the price calculated in step 510. The user 102 then has the option of purchasing the configuration of the product and/or service online, or while connected to the web site 104. Subsequently, the control flows back to step 504.

In one alternative, step 508 occurs before step 506. In this alternative, the web site 104 collects pricing information (step 506) from competitor web sites during or after the transaction of user 102 (step 508). That is, the web site 104 checks competitor pricing information after or during the user transaction of placing an order for a product or service. This allows the web site 104 to acquire the most up-to-date and accurate competitor pricing information possible. Subsequently, step 510 is executed, i.e., the web site 104 offers the product or service to the user 102 at the calculated price.

FIG. 6 is a flowchart depicting the operation and control flow of the price collection process of one embodiment of the present invention. FIG. 6 describes in more detail the process of determining competitor prices. The control flow of FIG. 6 begins with step 602 and flows directly to step 604.

In step 604, the web site 104 sends a spider 404 to collect price information 402 from the competing web sites, such as web site 106. In step 606, the spider 404 visits the web site 106 and selects one configuration of a product and/or service, as shown by example in FIG. 3. In step 608, the web site 106 offers the selected configuration of the product and/or service at a given price 402. In step 610, the spider 404 reads the price information 402 and sends it to the web site 104. In step 612, the web site 104 receives the price information 402 and stores it in the price factor database 410, so as to correspond with the selected configuration of the product and/or service of the web site 104. Subsequently, the control flows back to step 604.

Exemplary Implementations

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

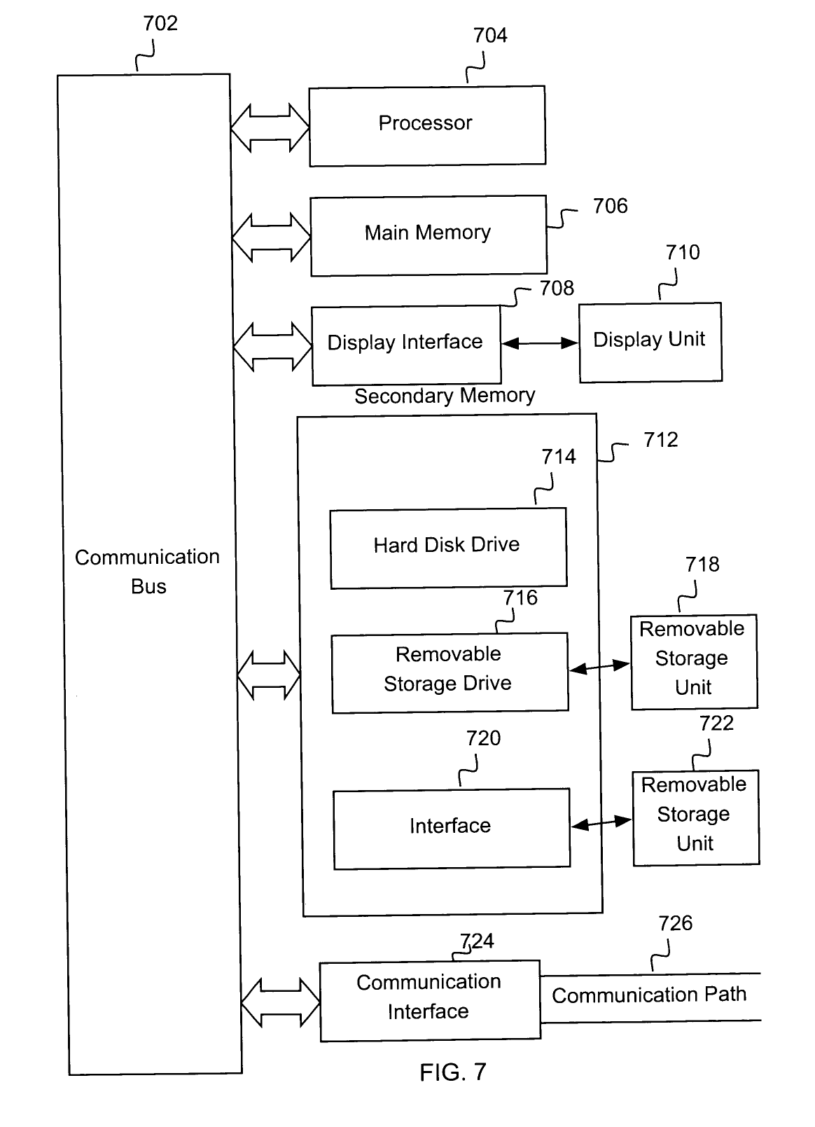

FIG. 7 is a block diagram of a computer system useful for implementing an embodiment of the present invention. The computer system includes one or more processors, such as processor 704. The processor 704 is connected to a communication infrastructure 702 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, etc. The removable storage drive 716 reads from and/or writes to a removable storage unit 718 in a manner well known to those having ordinary skill in the art. Removable storage unit 718, represents a floppy disk, magnetic tape, optical disk, etc. which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, etc. Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 706 and secondary memory 712, removable storage drive 716, a hard disk installed in hard disk drive 714, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

### CONCLUSION

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

1. A method on a web site for pricing a product and/or service, the method comprising:
offering a product and/or service for sale on a first web site, wherein the product and/or service is available for purchase in a plurality of configurations;
determining on a second web site a price for each of the plurality of configurations of the product and/or service;
calculating a price for each of the plurality of configurations of the product and/or service based on the prices determined from the second web site and at least one price factor; and
offering each of the plurality of configurations of the product and/or service for sale on the first web site for the calculated prices.

2. The method of claim 1, wherein the determining step comprises:
visiting the second web site;
selecting each of the plurality of configurations on the second web site; and
reading from the second web site a price associated with each of the plurality of configurations.

3. The method of claim 1, wherein the at least one price factor includes any one of:
the highest price that the market will bear for each of the plurality of configurations of the product and/or service on the first web site; and
the lowest profitable price at which the first web site can sell each of the plurality of configurations of the product and/or service.

4. The method of claim 3, wherein the at least one price factor further includes:
information associated with a buyer of the product and/or service on the first web site.

5. The method of claim 4, wherein the information associated with the buyer of the product and/or service on the first web site includes any one of:
the volume of the product and/or service that is being purchased by the buyer;
the number of orders previously placed by the buyer on the first web site;
the type of equipment owned by the buyer; and
the classification of the buyer.

6. The method of claim 1, wherein the product and/or service having a plurality of configurations is any one of:
furniture;
a computer;
a car; and
a boat.

7. The method of claim 6, wherein each of the first web site and the second web site are an e-commerce web site.

8. A computer program product comprising computer instructions on a web site for pricing a product and/or service, the computer instructions including instructions for:
offering a product and/or service for sale on a first web site, wherein the product and/or service is available for purchase in a plurality of configurations;
determining on a second web site a price for each of the plurality of configurations of the product and/or service;
calculating a price for each of the plurality of configurations of the product and/or service based on the prices determined from the second web site and at least one price factor; and
offering each of the plurality of configurations of the product and/or service for sale on the first web site for the calculated prices.

9. The computer program product of claim 8, wherein the instructions for determining comprise instructions for:
visiting the second web site;
selecting each of the plurality of configurations on the second web site; and
reading from the second web site a price associated with each of the plurality of configurations.

10. The computer program product of claim 8, wherein the at least one price factor includes any one of:
the highest price that the market will bear for each of the plurality of configurations of the product and/or service on the first web site; and
the lowest profitable price at which the first web site can sell each of the plurality of configurations of the product and/or service.

11. The computer program product of claim 10, wherein the at least one price factor further includes:
information associated with a buyer of the product and/or service on the first web site.

12. The computer program product of claim 11, wherein the information associated with the buyer of the product and/or service on the first web site includes any one of:
the volume of the product and/or service that is being purchased by the buyer;
the number of orders previously placed by the buyer on the first web site;
the type of equipment owned by the buyer; and
the classification of the buyer.

13. The computer program product of claim 8, wherein the product and/or service having a plurality of configurations is any one of:
furniture;
a computer;
a car; and
a boat.

14. The computer program product of claim 13, wherein each of the first web site and the second web site are an e-commerce web site.

15. A system for pricing a product and/or service, comprising:
a first web site for offering a product and/or service for sale, wherein the product and/or service is available for purchase in a plurality of configurations;
a spider for determining on a second web site a price for each of the plurality of configurations of the product and/or service;
a processor for calculating a price for each of the plurality of configurations of the product and/or service based on the prices determined from the second web site and at least one price factor; and
a price module for adjusting the prices of each of the plurality of configurations of the product and/or service to the prices calculated by the processor.

16. The system of claim 15, wherein the at least one price factor includes any one of:
the highest price that the market will bear for each of the plurality of configurations of the product and/or service on the first web site; and
the lowest profitable price at which the first web site can sell each of the plurality of configurations of the product and/or service.

17. The system of claim 16, wherein the at least one price factor further includes:
information associated with a buyer of the product and/or service on the first web site.

18. The system of claim 17, wherein the information associated with the buyer of the product and/or service on the first web site includes any one of:
the volume of the product and/or service that is being purchased by the buyer;
the number of orders previously placed by the buyer on the first web site;
the type of equipment owned by the buyer; and
the classification of the buyer.

19. The system of claim 15, wherein the product and/or service having a plurality of configurations is any one of:
furniture;
a computer;
a car; and
a boat.

20. The system of claim 19, wherein each of the first web site and the second web site are an e-commerce web site.
